(19) United States
(12) Patent Application Publication
(10) Pub. No.: US 2005/0104501 A1
(43) Pub. Date: May 19, 2005

(54) High efficiency gas discharge lamps

(75) Inventors: Earl F. Crandall, Raleigh, NC (US); Robert C. Smallwood SR., Englewood, CO (US)

Correspondence Address: BURNS DOANE SWECKER & MATHIS L L P, POST OFFICE BOX 1404, ALEXANDRIA, VA, 22313-1404, US

(73) Assignee: Transworld Lighting, Inc.

(21) Appl. No.: 10/817,706

(22) Filed: Apr. 2, 2004

Related U.S. Application Data
(60) Provisional application No. 60/460,756, filed on Apr. 4, 2003.

(51) Int. Cl. H01J 5/48; H01J 5/50

(52) U.S. Cl. 313/318.12; 313/318.01; 313/635; 313/634

(57) ABSTRACT

A gas discharge lamp includes an outer glass tube having a phosphor coating on an inner surface of the outer glass. An inner glass tube is positioned inside the outer glass tube and formed of glass that is transparent to UV light. The inner glass tube contains a plasma-forming gas within an inner volume of the glass tube. A high frequency ballast is integral to the outer glass tube and configured to provide a high frequency AC waveform for driving electrodes configured for energizing the plasma-forming gas within the inner glass tube to form plasma paths therein.

### RELATED APPLICATIONS

This application claims priority under 37 C.F.R. § 119 to provisional application Ser. No. 60/460,756 filed on Apr. 4, 2003, entitled “High Efficiency Gas Discharge Lamps,” which is incorporated by reference herein in its entirety.

### BACKGROUND

The present invention relates generally to gas discharge lamps. More specifically, this invention relates to gas discharge lamps having a smaller diameter plasma lamp within a larger lamp.

### SUMMARY

In one aspect of the invention, a gas discharge lamp includes an outer glass tube having a phosphor coating on an inner surface of the outer glass. An inner glass tube is positioned inside the outer glass tube and formed of glass that is transparent to UV light. The inner glass tube contains a plasma-forming gas within an inner volume of the glass tube. A high frequency ballast is integral to the outer glass tube and configured to provide a high frequency AC waveform for driving electrodes configured for energizing the plasma-forming gas within the inner glass tube to form plasma paths therein.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a schematic representation of cross section at the center of the length of the bulb according to an embodiment of the present invention.

FIG. 2 is a schematic representation of a side view of a hot cathode bulb end according to an embodiment of the present invention.

FIG. 3 is a schematic representation of a side view of a cold cathode bulb end according to an embodiment of the present invention.

### DETAILED DESCRIPTION

Gas discharge lamps, such as fluorescent lamps, generate light by creating a discharge or arc across an ionized gas within a glass tube. The traditional fluorescent lamp comprises a tube containing an inert gas and a material such as mercury vapor which, when ionized, can collide with electrons of a current flow across the electrodes of a lamp, and emit photons. These photons strike fluorescent material on the inner wall of the glass tube and produce visible light.

Fluorescent lamps require a ballast to control operation. The ballast conditions the electric power to produce the input characteristics needed for the lamp. When arcing, the lamp exhibits a negative resistance characteristic, and therefore needs some control to avoid a cascading discharge. Both manufacturers and the American National Standards Institute specify lamp characteristics, which include current, voltage, and starting conditions. Historically, 50-60 Hz ballasts relied on a heavy core of magnetic material; today, most modern ballasts are electronic.

Electronic ballasts can include a starting circuit and may or may not require heating of the lamp electrodes for starting or igniting the lamp. Prior to ignition, a lamp acts as an open circuit; when an arc is created the lamp starts, the entire ballast starting voltage is applied to the lamp. After ignition, the current through the lamp increases until the lamp voltage reaches equilibrium based on the ballast circuit. Ballasts can also have additional circuitry designed to filter electromagnetic interference (EMI), correct power factor errors for alternating current power sources, filter noise, etc.

Electronic ballasts typically use a rectifier and an oscillating circuit to create a pulsed flow of electricity to the lamp. Common electronic lighting ballasts convert 60 Hz line or input current into a direct current, and then back to a square wave alternating current to operate lamps near frequencies of 2040 kHz. Some lighting ballasts further convert the square wave to more of a sine wave, typically through an LC resonant lamp network to smooth out the pulses to create sinusoidal waveforms for the lamp. See, for example, U.S. Pat. No. 3,681,654 to Quinn, or U.S. Pat. No. 5,615,093 to Nalbant.

The square wave approach is common for a number of reasons. Many discrete or saturated switches are better suited to the production of a square wave than a sinusoidal wave. In lower frequency applications, a square wave provides more consistent lighting; a normal sinusoid at low frequency risks deionization of the gas as the voltage cycles below the discharge level. A square wave provides a number of other features, such as constant instantaneous lamp power, and favorable crest factors. With a square wave, current density in the lamp is generally stable, promoting long lamp life; similarly, there is little temperature fluctuation, which avoids flicker and discharge, damaging the lamp.

In general, energy can be saved by avoiding the cycle of decay and recovery of ionization within the lamp. It is thus desirable to minimize the deionization of the gas during the oscillatory application of power to the electrodes. One way to accomplish this is through the use of higher frequencies, which can be accomplished, for example, in the manner described in International Publication No. WO 03/019992, in order to minimize the effects of harmonic distortion. Another problem with lamps, in particular T8 and larger lamps, is the diameter of the gas plasma. The current density in the plasma is better in a small diameter lamp. Also, the plasma must be heated, so a smaller space reduces the amount that the plasma needs to be reheated to maintain its temperature. The present invention contemplates having a smaller diameter plasma lamp centered in a T8 lamp with the phosphor coating on the inside of the larger outer glass tube to reduce the diameter of the gas plasma and create a more desirable and more efficient plasma.

The present invention further contemplates that self ballasted gas discharge lamps may be configured with an integral ballast. In large commercial buildings and hi-rise buildings, much effort and cost is spent in replacing defective ballasts. The present invention contemplates a modified fluorescent light with the entire ballast included in one or both ends of the tube. This means that defective ballasts can be replaced by a bulb changer instead of an electrician. A ballast, according to the present invention, is small and has few components and is very efficient because of the very high operating frequency. (much greater than 100 KHz) The lamp will run cooler than a conventional ballasted lamp, making it possible to include the ballast either within the envelope or at one or both ends of the envelope. The present invention may be practiced with an external ballast connected in a manner that will be known to those in the art.

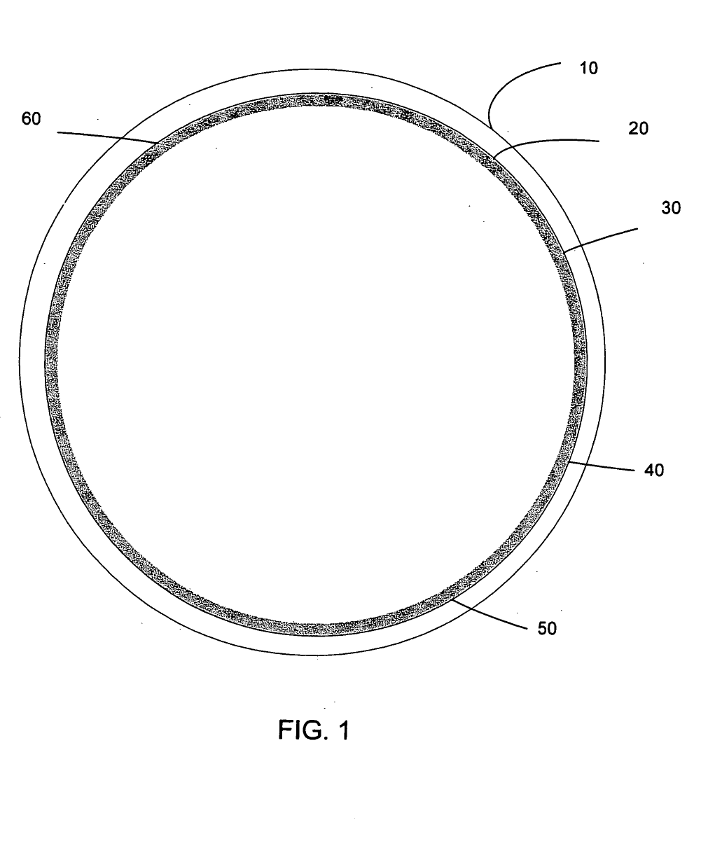

FIG. 1 is a schematic representation of a cross section of one type of gas discharge lamp 250. The cross section is at the center of the length of a bulb. In this view the generic concept of the invention can bee seen. The lamp 250 comprises a small diameter tube 40 in the center without any phosphorus coatings made of glass that is transparent to UV light and provides the UV light source. The outer glass 10 has the standard phosphor coating 20 on its inner surface 30. The outer glass 10 blocks any UV radiation that may pass thru the phosphor coatings 20.

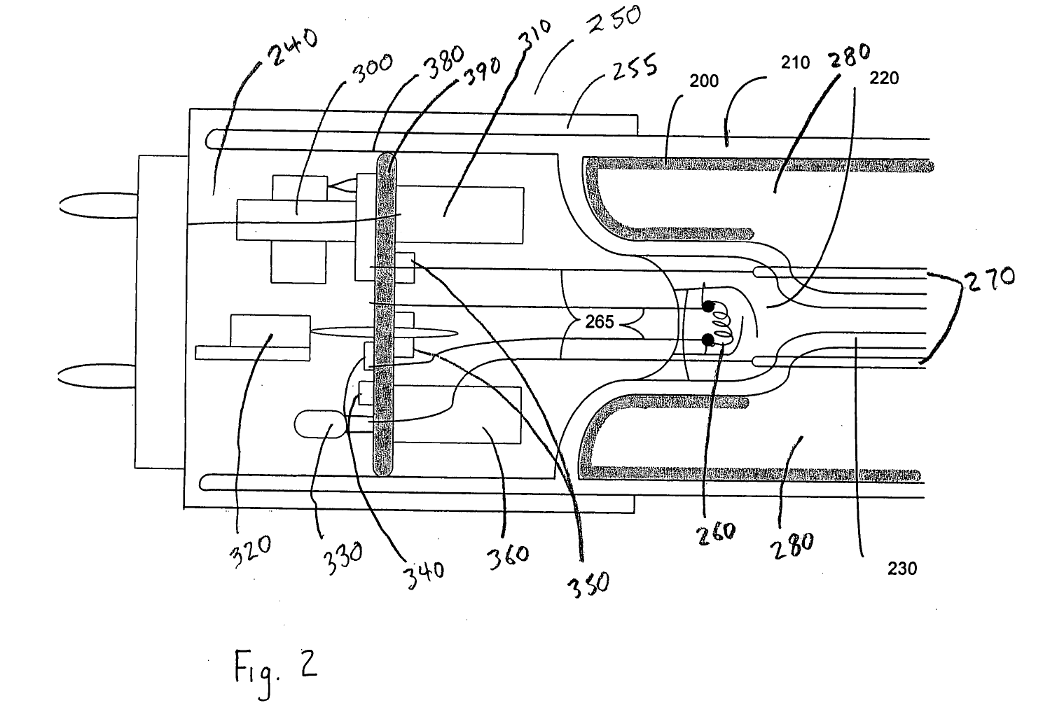

FIG. 2 is a schematic representation of a side view of gas discharge lamp 250 according to an embodiment of the invention. In this embodiment, the lamp 250 is a hot cathode comprising electrodes 260 configured for energizing a gas such as argon or xenon within the lamp 250 and forming plasma paths therein. In this particular embodiment, the lamp 250 is a T8 lamp having a diameter of approximately one inch, although those familiar with the art will recognize that other lamps and other diameters can be used.

Lamp 250 preferably comprises an integral ballast 240. The ballast 240 takes up some portion of the end of the lamp. In an exemplary embodiment, the ballast may include the following components, as shown generally in FIG. 2; an inductor 300, a typical capacitor 310, 330, and 360, a typical power transistor (semiconductor) 320 and surface mount components 340, 350. The ballast shown is an exemplary ballast. Those of skill in the art will recognize other ballast designs that could work with the invention. The integral ballast 240 powers the bulb and its filaments 260, and may require a small glass tube 270 to carry the filament wires 265 to the opposite end. The ballast 240 could also be included in an extended end cap 255 external to the lamp in keeping with an embodiment of the invention. Lamp 250 also includes an outer gas 280, which may be dry nitrogen, which is preferably pumped to bring the gas to a near vacuum, or to a level known by those skilled in the art would know to reduce thermal conduction to required levels. An outer gas 280 can be any gas that is not very conductive to heat, or just a simple vacuum.

Lamp 250 further comprises a small diameter tube 230 preferably in the center of the lamp 250, or placed where those familiar with the art would specify, without any phosphorus coatings made of glass that is transparent to UV light and provides a UV light source. In a particular embodiment small diameter tube 230 has a diameter ⅜ of an inch or less. Lamp 250 further comprises outer glass 210 that has a phosphor coating 200 on its inner surface. The outer glass 210 blocks any UV radiation that may pass thru the phosphor coating 200.

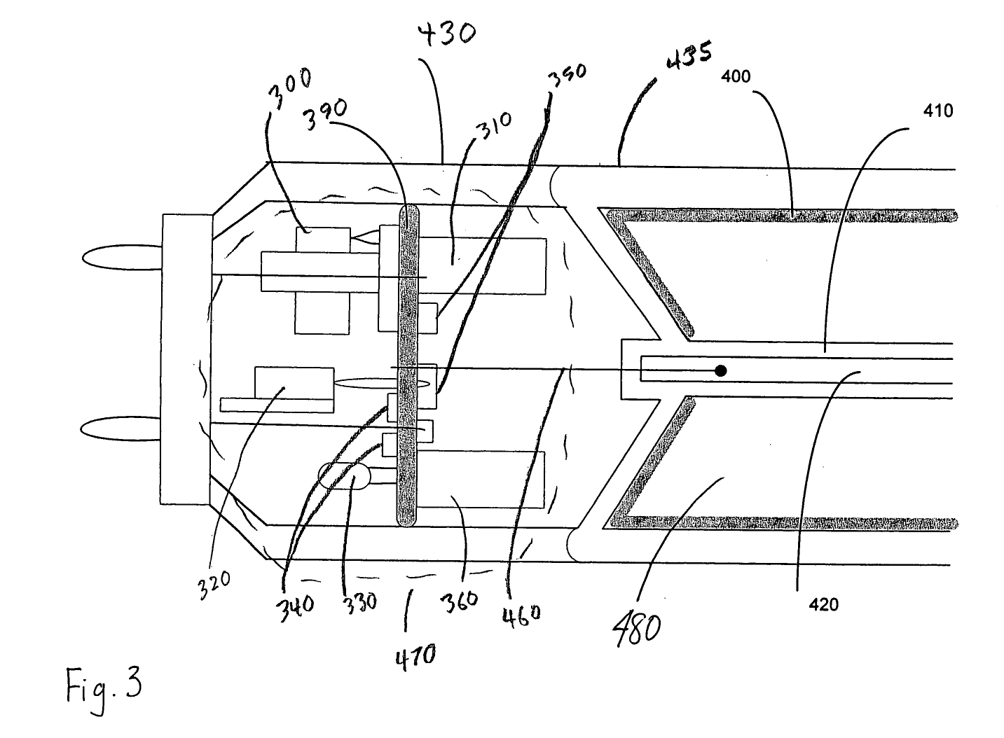

FIG. 3 a schematic representation of a side view of gas discharge lamp 450 according to another embodiment of the invention. As shown, the lamp 450 is a cold cathode comprising electrodes 460 configured for energizing a gas such as argon or xenon, or any gas known by those skilled in the art, within the lamp 250 and forming plasma paths therein, when energized by the ballast. Lamp 450 is a linear lamp, preferably with an integral ballast 470. This embodiment uses cold cathodes and is therefore more efficient than the hot cathode embodiment shown in FIG. 2. The ballast 470 takes up a portion of the end of the lamp. Similarly numbered components in the FIG. 2 are the same as components in FIG. 3. The integral ballast 470 powers the bulb, and may require a small glass tube (not shown) to carry the electrode wire to the opposite end. The ballast could also be included in an extended end cap external to the lamp in keeping with an embodiment of the invention.

As above, lamp 450 comprises a small diameter tube 410 in the center without any phosphorus coatings made of glass that is transparent to UV light which provides the UV light source. An outer glass 435 has the standard phosphor coating 400 on its inner surface 480. The outer glass 435 blocks any UV radiation that may pass thru the phosphor coatings 400. Lamp 450 also includes an outer gas 480, which may be dry nitrogen, which is preferably pumped to bring the gas to a near vacuum, or to a level known by those skilled in the art would know to reduce thermal conduction to required level. An outer gas 480 can be any gas that is not very conductive to heat, or just a simple vacuum. A small wire (not shown) may pass thru this vacuum to power the far end of the tube.

The far end of the bulb may have a single plastic dummy pin for mechanical positioning and retention of the tube. This is done so that customers can place the tube in only one position. Alternatively, both ends of the lamp could be powered, with only one end having the pins connected. Other connection and mounting methods may be easily developed by those skilled in the art.

It will be appreciated by those of ordinary skill in the art that the invention can be embodied in various specific forms without departing from its essential characteristics. The disclosed embodiments are considered in all respects to be illustrative and not restrictive. The scope of the invention is indicated by the appended claims, rather than the foregoing description, and all changes that come within the meaning and range of equivalents thereof are intended to be embraced thereby.

It should be emphasized that the terms “comprises”, “comprising”, “includes”, and “including”, when used in this description and claims, are taken to specify the presence of stated features, steps, or components, but the use of these terms does not preclude the presence or addition of one or more other features, steps, components, or groups thereof.

1. A gas discharge lamp, comprising:
an outer glass tube having a phosphor coating on an inner surface of the outer glass;
an inner glass tube positioned inside the outer glass tube and formed of glass that is transparent to UV light, the inner glass tube containing a plasma-forming gas within an inner volume of the glass tube; and
a high frequency ballast integral to the outer glass tube and configured to provide a high frequency AC waveform for driving electrodes configured for energizing the plasma-forming gas within the inner glass tube to form plasma paths therein.

2. The gas discharge lamp of claim 1, wherein the high frequency AC waveform is in a frequency range of about 100 KHz to about 450 KHz.

3. The gas discharge lamp of claim 1, wherein the inner glass tube comprises UV transparent material.

4. The gas discharge lamp of claim 1, wherein the plasma-forming gas includes at least one of argon and xenon.

5. The gas discharge lamp of claim 1, wherein the phosphor coating is configured to convert UV photons emitted by the inner glass tube into visible light photons.

6. The gas discharge lamp of claim 5, wherein the outer glass tube is configured to block UV photons that are not converted by the phosphor coating.

7. The gas discharge lamp of claim 1, wherein the ballast is hosed in an extended end cap of the outer glass tube.

8. The gas discharge lamp of claim 1, comprising at least a third glass tube to carry filament wires from the integral ballast to an end cap at an opposite end of the outer glass tube.

9. The gas discharge lamp of claim 1, wherein the inner volume of the outer glass tube includes dry nitrogen.

10. The gas discharge lamp of claim 1, wherein an end cap far of the outer glass tube includes a dummy pin for mechanical positioning and retention of the tube.
